(19) United States
(12) Patent Application Publication
(10) Pub. No.: US 2023/0386522 A1
(43) Pub. Date: Nov. 30, 2023

(54) COMPUTING SYSTEM THAT APPLIES EDITS MODEL FROM PUBLISHED VIDEO TO SECOND VIDEO

(71) Applicant: Lemon Inc., Grand Cayman (KY)

(72) Inventors: Michael Buzinover, Culver City, CA (US); Tiancheng Yang, Culver City, CA (US); Zhuguang Wang, Culver City, CA (US); Tianyu Shi, Culver City, CA (US)

(21) Appl. No.: 17/804,277

(22) Filed: May 26, 2022

(51) Int. Cl. G11B 27/036; G11B 27/10; G06F 3/04845; H04L 67/06

(52) U.S. Cl. CPC G11B 27/036; G11B 27/10; G06F 3/04845; H04L 67/06; G06F 2203/04804; G06F 3/04842

(57) ABSTRACT

A computing system is provided which includes a client computing device including a processor. The processor is configured to execute a client program to display a first video published by a first user on a video server platform, to a second user. The processor is configured to execute the client program to display a graphical user interface. The graphical user interface includes a selectable input component configured to enable selection of an edits model of the first video. The edits model includes a series of edit operations applied to the first video. The processor is configured to execute the client program to, in response to selection of the selectable input component, apply the edit operations to a second video. The processor is configured to execute the client program to publish the second video by the second user on the video server platform for viewing by other users.

### BACKGROUND

In a social media platform that is provided for users to upload original content and interact with each other's content, viral trends commonly occur in which various users attempt to repeat an original concept, sometimes by including their own modifications. A derivative version of the original concept may even become more popular than the original, despite owing its start to the user who provided the original concept. The original user may feel that their original concept was misappropriated in such a case. In addition, a platform hosting such uploaded content may have a high barrier for entry of new users who are not yet familiar with the various editing options available for generating the content, or may not feel creative enough to develop their own ideas into original content.

### SUMMARY

To address these issues, a computing system is provided herein that includes a client computing device including a processor. The processor may be configured to execute a client program to display a first video published by a first user on a video server platform, to a second user viewing the first video. The processor may be configured to execute the client program to display a graphical user interface. The graphical user interface may include a selectable input component configured to enable selection of an edits model of the first video. The edits model may include a series of edit operations applied to the first video. The processor may be configured to execute the client program to, in response to selection of the selectable input component, apply the edit operations to a second video. The processor may be configured to execute the client program to publish the second video by the second user on the video server platform for viewing by other users.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system according to the present disclosure.

FIG. 2 shows another schematic view of the computing system of FIG. 1.

FIG. 3 shows a schematic view of communication between an application server program and client program of the computing system of FIG. 1.

FIG. 4 shows an example edits model used in the computing system of FIG. 1.

FIG. 5 shows an example video publishing screen of a graphical user interface (GUI) of the computing system of FIG. 1.

FIG. 6 shows an example video viewing screen of the GUI of the computing system of FIG. 1 over time.

FIG. 7 shows an example video sharing screen of the GUI of the computing system of FIG. 1.

FIG. 8 shows an example inspired screen of the GUI of the computing system of FIG. 1.

FIG. 9 shows an example video editing screen of the GUI of the computing system of FIG. 1 over time.

FIG. 10 shows the example video editing screen of FIG. 10 with further modifications.

FIG. 11 shows an example video viewing screen of the GUI of the computing system of FIG. 1.

FIG. 12 shows an example flowchart of a method according to one example of the present disclosure.

FIG. 13 shows a schematic view of an example computing environment in which the computing system of FIG. 1 may be enacted.

### DETAILED DESCRIPTION

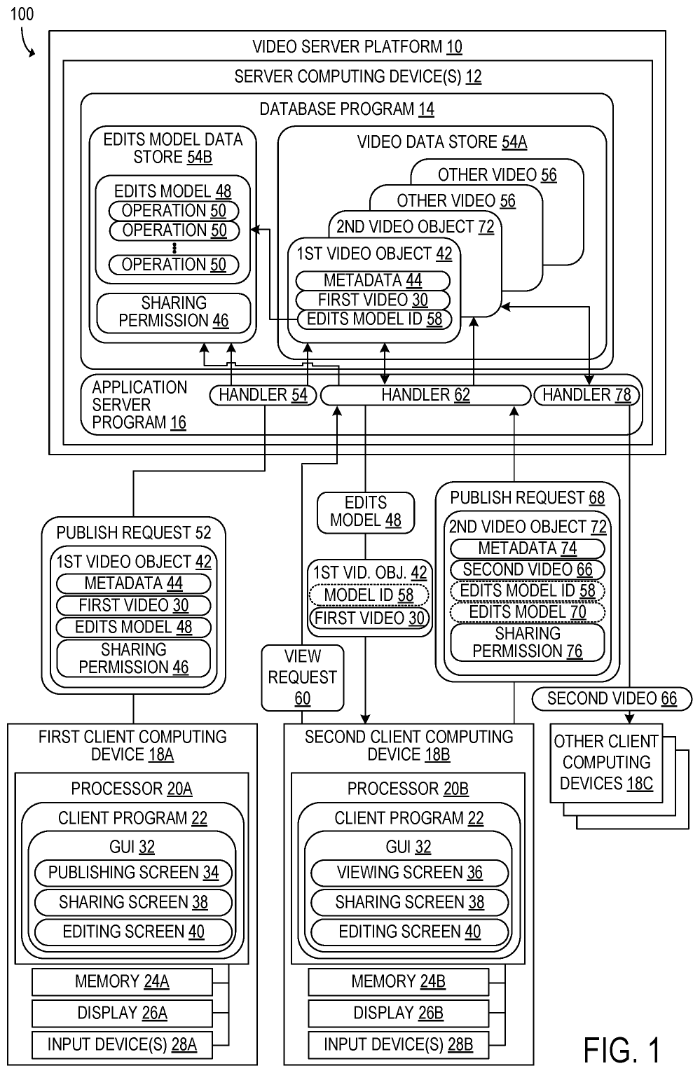

To address the above issues, FIG. 1 illustrates an example computing system 100. The computing system 100 includes a video server platform 10 comprising at least one server computing device 12. The video server platform 10 may be a social media platform in which users can upload and view videos, browse and search for videos available to watch, leave comments, etc. The server computing device 12 may include processing circuitry (e.g., logic processor 1302 to be described later) configured to execute a database program 14 to store and maintain data on the server computing device 12, and an application server program 16, which may be the server-side program executed to implement server-side functions of the video server platform 10.

On the client side of the computing system 100, a first client computing device 18A, a second client computing device 18B, and other client computing devices 18C may be used by associated users to interact with the application server program 16. Each client computing device 18A-C may be of any suitable type such as a smartphone, tablet, personal computer, laptop, wearable electronic device, etc. able to access the video server platform 10 via an internet connection. The first client computing device 18A may include a processor 20A configured to execute a client program 22 to enact various client-side functions of the video server platform 10 on behalf of a first user. The first client computing device 18A may further include associated memory 24A for storing data and instructions, a display 26A, and at least one input device 28A of any suitable type, such as a touchscreen, keyboard, buttons, accelerometer, microphone, camera, etc., for receiving user input from the first user. In this example, the first user is a content originator who is providing new, original content on the video server platform 10 for consumption by other users.

First, the first user creates a first video 30 to be published on the video server platform 10. The processor 20A may be configured to execute the client program 22 to present a graphical user interface (GUI) 32 to the first user on the display 26A. The GUI 32 may include a plurality of pages, screens, windows, or sub-interfaces providing various functions. For example, a video publishing screen 34 may be used to finalize details and settings before publishing a finished video; a video viewing screen 36 may be used to select and view another user's published videos; a video sharing screen 38 may present a number of options to the viewing user for interacting with the viewed video such as adding the video to a list or favorites collection, reacting to the video, sharing a link to the video over a connected social media or communications account, downloading the video, and so on; and a video editing screen 40 may be used to film and/or edit a video to be published. Additional screens may be provided to provide additional features.

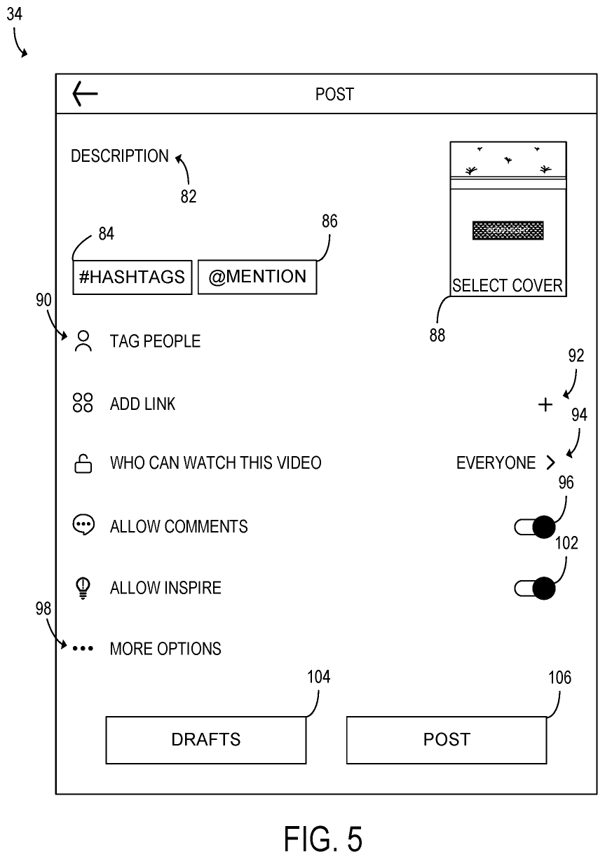

The first client computing device 18A may prepare the first video 30 using the video editing screen 40. The first video 30 may be packaged inside a first video object 42 with metadata 44 such as a location, model, and operating system of the first client computing device 18A, and a sharing permission 46. The sharing permission 46 may apply to all options of the video sharing screen 38, or any individual options. The sharing permission 46 may be an account-wide setting or a setting for individual videos. The first user may be able to set the sharing permission 46 via a selectable GUI component such as a switch, tick box, drop down menu, etc. (see FIG. 5). The sharing permission 46 may be set at the time of publishing the first video 30, revised after publishing for sharing activity going forward, or set account-wide at any time in an account settings screen. The server computing device 12 may be configured to receive the sharing permission 46 from the first user and enable or disable sharing accordingly. The first video object 42 may further include an edits model 48, the edits model 48 including a series of edit operations 50 applied to the first video 30. For the present disclosure, the sharing permission 46 applies at least to an edits sharing function that will be described herein, and for the first video 30, the sharing permission 46 indicates that the edits model 48 of the first video 30 can be shared with and used by other users of the video server platform 10. The first client computing device 18A may send the first video object 42 in a publish request 52 to the server computing device 12. The application server program 16 may include a plurality of handlers to process data transfer requests. A handler 54 may receive the publish request 52 and store the first video object 42 in a video data store 54A with other videos 56 from other users.

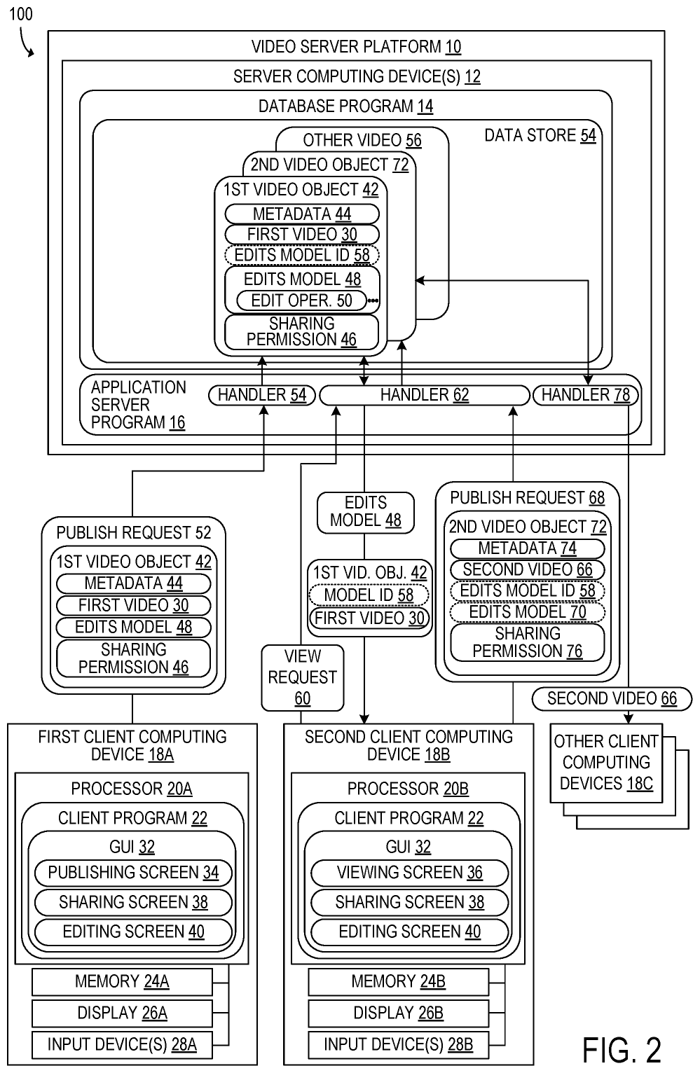

FIG. 1 and FIG. 2 differ in that the database program 14 of FIG. 1 includes a separate edits model data store 54B in which the edits models of various users, including the edits model 48, are stored, along with the sharing permission 46 permitting or denying sharing of the edits model 48 with other users. The first video 30 is correlated to the stored edits model 48 with an edits model identifier 58, in the first video object 42, which may be a pointer or URL referencing a stored location of the edits model 48. In contrast, as shown in FIG. 2, the video server platform 10 may be configured to store the edits model 48 in the first video object 42 including the first video 30 in, for example, a single data store 54.

The second client computing device 18B, similar to the first client computing device 18A, may include a processor 20B configured to execute the client program 22 to display the GUI 32 including at least the video viewing screen 36, the video sharing screen 38, and the video editing screen 40, as well as associated memory 24B, a display 26B, and at least one input device 28B. Each of these components correspond to the same named components of the first client computing device 18A, and therefore the same description will not be repeated. As with the first computing device 18A, more screens may be presented in the GUI 32 than are shown in FIGS. 1 and 2. Once the server computing device 12 publishes the first video 30 on the video server platform 10, the user of the second client computing device 18B may be inspired by the first video 30 and want to join in on a trend. Accordingly, the second client computing device 18B may send a view request 60 to the video server platform 10 via a handler 62 of the application server program 16. In response, the handler 62 may send the second client computing device 18B data to display the first video 30 published by the first user on the video server platform 10, to the second user viewing the first video 30. The application server program 16 may send the first video object 42 with the first video 30 and the edits model 48 together, or may send the edits model identifier 58 first. The metadata 44 may be omitted from the first video object 42 sent to the second client computing device 18B to protect user privacy. Using the edits model identifier 58 rather than sending the edits model 48 upfront may reduce the amount of data to be transferred, particularly if the edits model 48 is a large file. However, it may be advantageous to send the edits model 48 upfront, for example, if the first video 30 is a high conversion video that is inspiring a lot of viewers to reuse the edits model 48 to make their own videos.

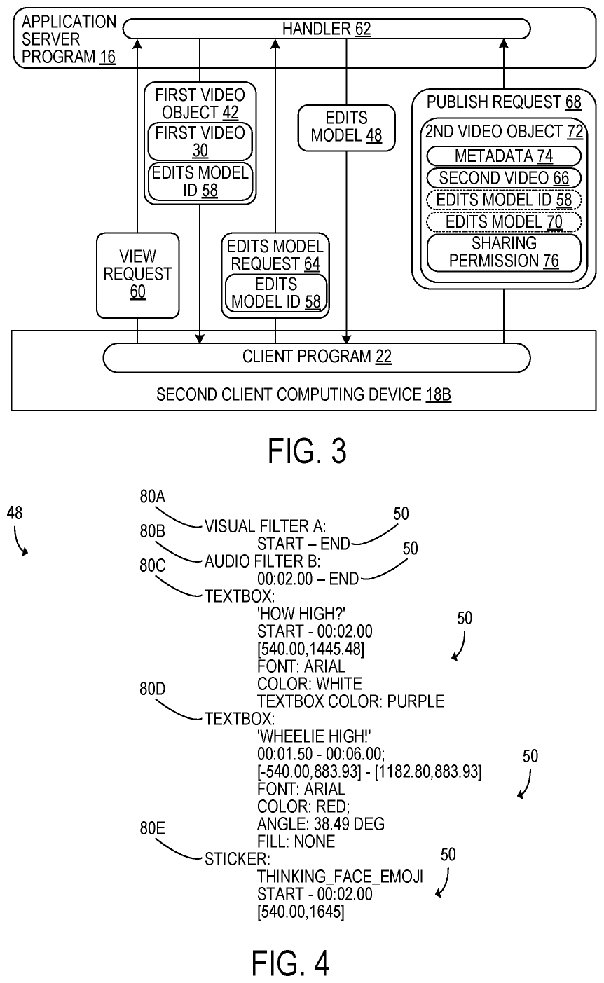

If the edits model 48 is not included together with the first video 30, then the second user may select a GUI component, for example, on the video sharing screen 38, to send an edits model request 64 indicating the edits model identifier 58 to the handler 62, as shown in FIG. 3 in more detail. In response, the handler 62 may send the edits model 48 to the second client computing device 18B so that the second user can reuse the edits model 48 in a new video. Regardless of the data packaging, selecting the GUI component may result in the client program 22 applying the edit operations 50 in the edits model 48 to a second video 66. The second user may begin filming the second video 66 at this point, or preexisting footage may be selected in the video editing screen 40.

The second user may complete the second video 66 with the exact same edit operations 50 of the edits model 48, in which case the edits model 48 may be omitted from a publish request 68 if desired, and the edits model identifier 58 may be used to associate the already stored edits model 48 with the second video 66 on the server computing device 12. Alternatively, in some implementations, the second user may be permitted to further modify one or more of the edit operations 50 and send back a modified edits model 70 to the handler 62 of the application server program 16. The modified edits model 70 may be associated with the original edits model 48 so that the first user is still credited with inspiration for the second video 66. That is, the edits model 48 of the second video 66 may be the same as or partially different from the edits model 48 of the first video 30. By sending the publish request 68 including a second video object 72 including metadata 74, the second video 66, sharing permission 76, as well as the edits model identifier 58 and/or edits model 48 as discussed above, the client program 22 may cause the application server program 16 to publish the second video 66 by the second user on the video server platform 10 for viewing by other users. Other users may be able to view the second video 66 provided by a handler 78 of the application server program 16 via their own other client computing devices 18C providing the video viewing screen 36.

FIG. 4 shows an example edits model 48 used in the first video 30. The edit operations 50 may include timed operations configured to be effected at predetermined timestamps along the first video 30, and/or audiovisual effects that are sustained throughout the entire first video 30. Many of the edit operations 50 may affect the position of a visual edit on the first video 30. For example, as shown, the edit operations 50 may include at least one of adding a text box, formatting the text box, applying a filter, adding a sticker, adding or modifying an audio track, setting coordinates of the text box or sticker, or setting a timing of the text box or sticker. In the illustrated example, a visual filter 80A that modifies the appearance of the first video 30 is added for the entire duration of the first video 30 as one of the series of edit operations 50. An audio filter 80B that modifies an audio track of the first video 30 is added beginning at the two second mark and ending at the end of the first video 30 as one of the series of edit operations 50. Alternatively or in addition, an audio track such as a song may be selected from a catalog of audio files. A first textbox 80C is added, reading “HOW HIGH?” at a specified coordinate point and for a specified time period as edit operations 50. The font, text color, and textbox color are further specified as edit operations 50. A second text box 80D is added, reading “WHEELIE HIGH!” at a starting and ending coordinate point and for a specified time period as edit operations 50. The font, text color, tilt angle, and lack of textbox fill are further specified as edit operations 50. In some instances, modifications such as stickers may be added to videos. Stickers are graphics that may be illustrations or portions of images that may be stamped over the video, and may be animated or still. Here, a “THINKING_FACE_EMOJI” sticker 80E is added for a specified time period and at a specified coordinate, although the sticker is not included in illustrations of the first video 30. The stickers may be selected from a preexisting catalog or created by the first user. The example of FIG. 4 is merely for the purpose of illustration and many other edit operations 50 may be utilized.

FIG. 5 illustrates an example of the video publishing screen 34 of the GUI 32. Here, the first user may enter a description 82, select a hashtags component 84 to add hashtags, or select an @mention component 86 to mention another user's account. The user may also select a cover image 88, which may be used when referencing the video such as when presenting search results or a collection of videos such as on the first user's profile page. The video publishing screen 34 may further include a GUI component 90 to tag other users, a GUI component 92 to add a hyperlink, a GUI component 94 to set viewing permissions of the first video 30, a GUI component 96 to permit or deny comments to be added in response to the first video 30, and a GUI component 98 to see more options. The video publishing screen 34 may further include a GUI component 102 to set the sharing permission 46 for the first video 30. The GUI component 102 is illustrated as a toggle switch by way of example but may take other forms such as a drop-down menu, a virtually depressible button, or a tick box. The default setting may be either enabled or disabled. Furthermore, the permissions setting may be present in an account-level settings page rather than in the video publishing screen 34 for a specific video. Here, the first user as enabled sharing of the first video 30 in an edits sharing (“INSPIRE”) mode. Finally, the first user may select a GUI component 104 to save the first video as a draft, or a GUI component 106 to publish the first video 30 on the video server platform 10.

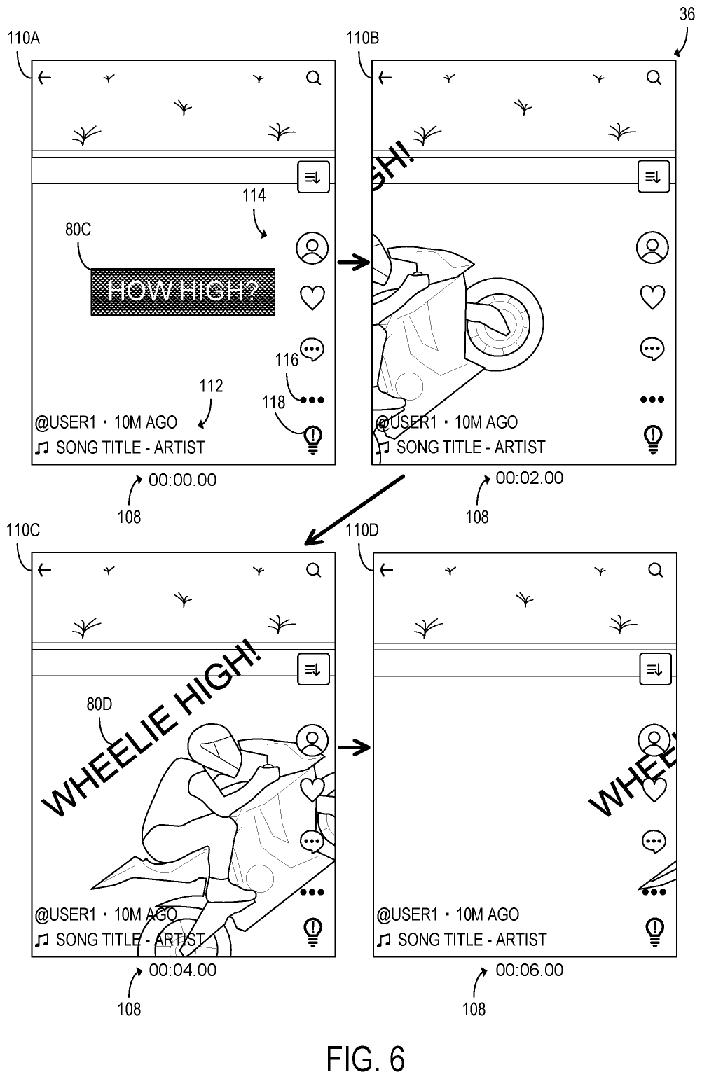

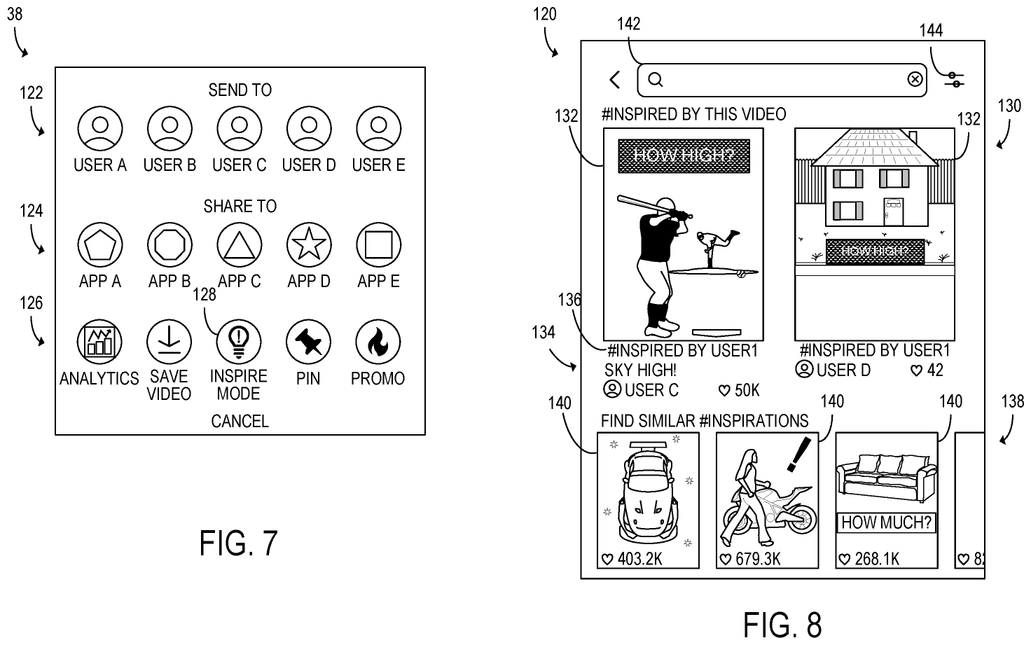

FIG. 6 shows an example of the video viewing screen 36 displaying the first video 30 for the second user. As shown, the first video 30 includes many of the example edit operations 50 listed in the example edits model 48 of FIG. 4, such as the first and second textboxes 80C, 80D. A timestamp 108 indicates the time of each corresponding frame 110A-D illustrated here. Information 112 regarding the first video 30 may be indicated, such as the user account (@USER1) of the first user, the time elapsed since the first video 30 was published, and the title and artist of a song used in the first video 30. The visual content of the first video 30 includes, after the first textbox 80C ends, a motorcycle rider riding across the camera field of view from left to right, with the second textbox 80D angled approximately the same angle as the motorcycle and pinned above the motorcycle to follow its location across the screen. The video viewing screen 36 may include selectable GUI components 114 for receiving user input in order for the second user to interact with the first video 30 by exiting, searching for other videos or user accounts, adding the first video 30 to a list, visiting a profile page of the first user, or liking the first video 30, etc. A sharing component 116 may be selected by the second user, for example, by tapping on a touch screen or clicking with a mouse, to launch the video sharing screen 38, an example of which is illustrated in FIG. 7. An inspired component 118 may be selected by the second user to launch an inspired screen 120 presenting other videos for viewing that have been made using the same edits model 48 as the first video 30, an example of which is illustrated in FIG. 8.

Turning to FIG. 7, the video sharing screen 38 may include several options for sharing the first video 30. A contact pane 122 may be included to send a link to the first video 30 to known contacts on the first client computing device 18A. An application pane 124 may be included to send a link or create a post advertising the first video 30 via common applications such as social media or messaging applications. An action pane 126 may be included to provide actions for the second user to perform regarding the first video 30, such as downloading the video. In particular, the GUI 32 may include a selectable input component 128 configured to enable selection of the edits model 48 of the first video 30 by engaging the second user in an “INSPIRE MODE.” The selectable input component 128 is illustrated as a selectable virtual button but may take any suitable form. It will be appreciated that the video sharing screen 38 of the GUI 32 may include the selectable input component 128, or another suitable screen of the GUI 32 may include the selectable input component 128. For example, a component on the video viewing screen 36 of FIG. 6 could be used as the selectable input component 128 for entering the INSPIRE MODE, or a component in a browsable list of selectable edits models from one or more users.

Turning to FIG. 8, the second client computing device 18B may be further configured to execute the client program 22 to display the inspired screen 120. The inspired screen 120 may include suggestions of videos to view or user accounts to follow for the second user. An inspired pane 130 may display a plurality of videos 132 that include the edits model 48 of the first video 30. Data 134 about the respective videos 132 may include, for example, the posting user account, a like count, and a text description, in addition to an indication of credit 136 to the first user. The data 134 may form a list of user accounts that published the plurality of videos 130. A similar inspirations pane 138 may include videos 140 algorithmically determined to be similar to the first video 30 or the edits model 48 and displayed for the second user. The inspired screen 120 may include a search bar 142 and a filter control component 144 for targeting desired videos and accounts within the inspired screen 120.

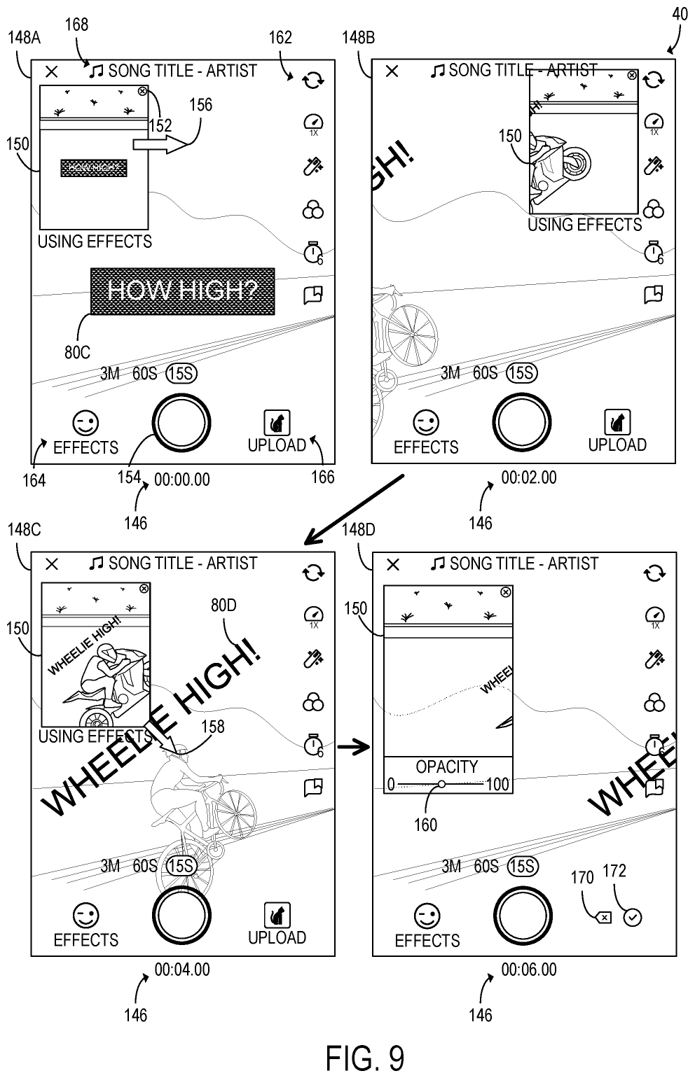

As mentioned above, the GUI 32 may further include a video editing screen 40. FIG. 9 shows an example of the video editing screen 40 of the GUI 32 over time as the second user creates the second video 66. The video editing screen 40 may have been launched after the second user selected the selectable input component 128. As with FIG. 6, a timestamp 146 indicates the time of each corresponding frame 148A-D illustrated here. The processor 20B may be configured to execute the client program 22 to, in response to selection of the selectable input component 128, apply the edit operations 50 to the second video 66. Further, the client program 22 may be permitted to apply the edit operations 50 to the second video 66 based at least on the sharing permission 46 of the first user. Since the first user enabled sharing of the edits model 48, the second user is able to reuse the edits model 48 when creating the second video 66. As illustrated, the series of edit operations 50 from the first video 30 including the textboxes 80C, 80D have been pre-loaded on the second video 66. The edit operations 50 may be displayed during filming, or may appear during an edit phase after filming is complete.

In some instances, the video editing screen 40 further includes a reference video 150 of the first video 30 that is displayed over the second video 66. Here, the reference video 150 is illustrated as a thumbnail, but may be a full-size overlay or may be displayed in a split-screen formation. The second user may therefore be able to easily create the second video 66 to have the correct content at the correct time in order to follow the flow of the series of edit operations 50. A GUI component 152 may be selected to close the reference video 150 if desired. As can be seen by comparing corresponding frames 110A-D, 148A-D at the same timestamp, the reference video 150 may be configured to play and pause in sync with the second video 66 during video filming and/or editing of the second video 66. Accordingly, if the second user pauses recording of the second video 66 via a play/pause button 154, the reference video 150 may be paused at the same point and the two videos 66, 150 will not go out of sync. As such, the reference video 150 may be a useful aid for the second user to look at when creating the second video 66. The reference video 150 may be adjustable in at least one of transparency, size, and position by the second user in the video editing screen 40. For example, the second user may apply an input 156 to drag the reference video 150 across the screen to a new position in frame 148A. The second user may apply an input 158 in frame 148C to increase the size of the reference video, with a reverse action able to decrease the size instead. The second user may be able to access an opacity pane and adjust a selectable GUI component 160, which may be a slider bar or up/down arrow, etc., to adjust the transparency of the reference video 150.

In the edit screen, the second user may have access to many edit functions. A plurality of selectable GUI components 162 may be displayed to switch between front and rear facing cameras, adjust the recording speed, adjust photography settings, apply a filter, set a filming delay timer, etc. An effects component 164 may be selectable to access a catalog of usable effects to be applied to the second video 66. An upload component 166 may be selectable to retrieve footage stored in a camera reel or remote storage of the second client computing device 18B rather than using the camera to record within the client program 22. An audio description 168 may include information about an audio track used with the second video 66, which may be original or selected from a catalog of available tracks. The default audio track may be the same audio track used in the first video 30 as part of the edits model 48 applied to the second video 66. Once the second user is finished with the second video 66, a cancel button 170 may be used to cancel the prepared video, or an accept button 172 may be used to proceed to final touches before publishing.

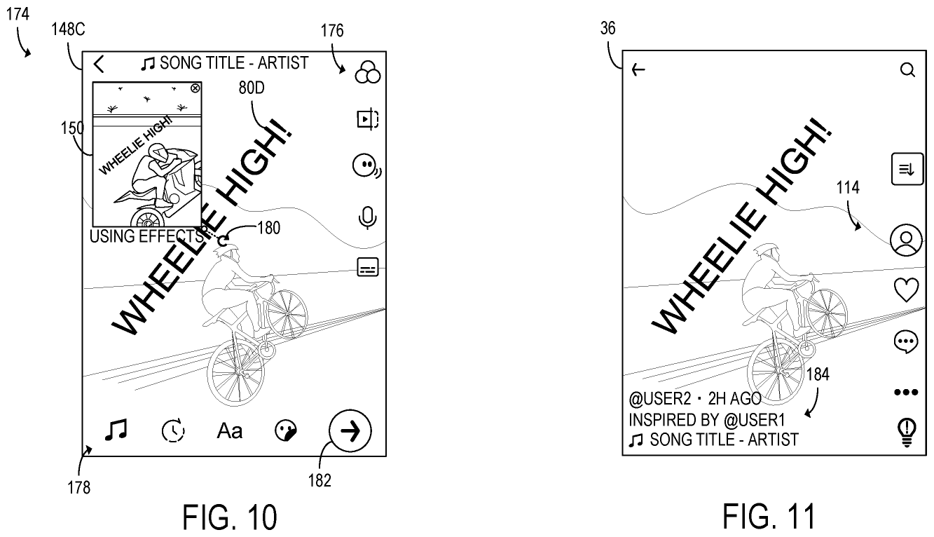

The second user may use the edits model 48 of the first video 30 as-is when publishing the second video 66. Alternatively, with reference to FIG. 10, the GUI 32 is configured to, after the edit operations 50 are applied, permit modifications of one or more of the edit operations 50 by the second user before the second video 66 is published. For example, the subject riding a bicycle in the second video 66 may be riding at a different angle than the motorcycle rider in the first video 30, and the second user may decide that the second textbox 80D should be arranged at a matching angle. As such, selecting the accept button 172 may proceed to a video editing subscreen 174 providing more options for editing the second video 66. A plurality of selectable GUI components 176 may provide access to filters, video clip adjustment, voice effects, voiceover, and captions, for example. Another plurality of selectable GUI components 178 may provide access to additional sounds, effects, textboxes, or stickers, for example. The video editing subscreen 174 may receive an input 180 from the second user rotating the second textbox 80D, which may be performed by a one- or two-finger rotational input, for example. As illustrated, the second user adjusted the second textbox 80D to an angle of 52 degrees. The second user may save changes and proceed to the same video publishing screen 34 described above with reference to the first video 30 by selecting a GUI component 182. In this example where the second user further modifies the edits model 70, the edits model 70 may be updated to reflect the new angle and any other modifications or additions to the edit operations 50 and sent together with the publish request 68 to the video server platform 10. A new edits model identifier may be created to correspond to the modified edits model 70.

Another example of the video viewing screen 36 is illustrated in FIG. 11, displaying the second video 66 for other users to view. Similar functions may be presented as when the example video viewing screen 36 showed the first video 30, for example, via the selectable GUI components 114. Here, after the edit operations 50 are applied as discussed above, the second video 66 may include an indication of credit 184 to the first user. The indication may include one or more of the account name of the first user, a link to the first user's profile and/or the first video 30, a phrase such as “INSPIRED BY” indicating that the second user is not the original creator, and so on. In this manner, the first user may be reassured that their contributions to the video server platform 10 are not claimed by others. Furthermore, in some implementations, if the second user receives compensation for the success (e.g., number of views or subsequently inspired videos), a portion of the compensation may be forwarded to the first user for the inspiration.

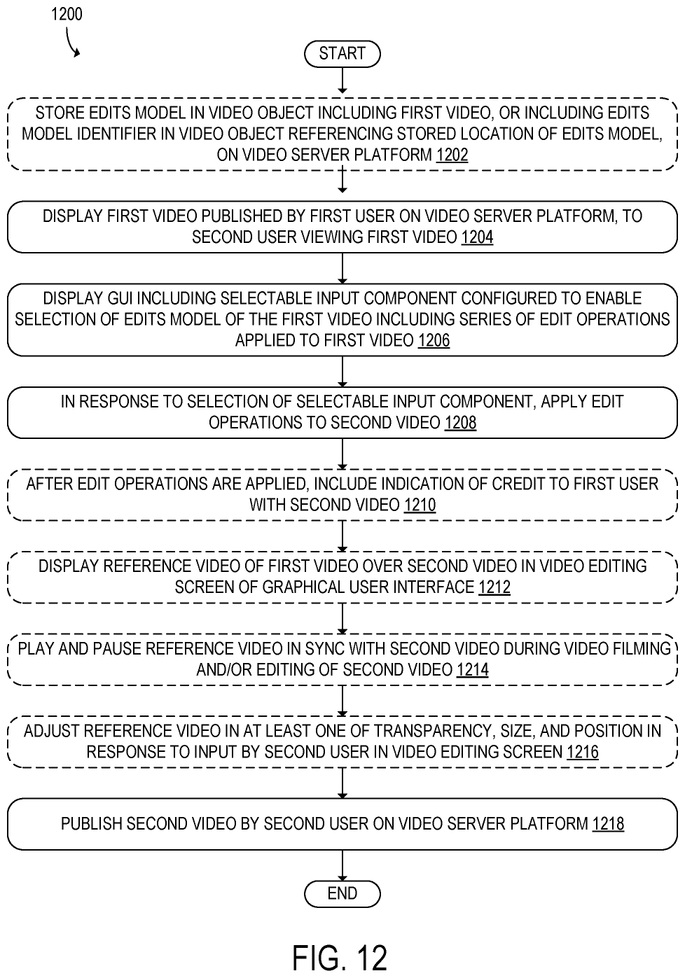

FIG. 12 shows a flowchart for a method 1200 according to the present disclosure. The method 1200 may be implemented by the computing system 100 illustrated in FIGS. 1 and 2. At 1202, the method 1200 may optionally include storing an edits model in a video object including a first video, or including an edits model identifier in the video object referencing a stored location of the edits model, on a video server platform. As discussed above, the edits model identifier may be used to reduce the amount of data transmitted. At 1204, the method 1200 may include displaying the first video published by a first user on the video server platform, to a second user viewing the first video. At 1206, the method 1200 may include displaying a graphical user interface including a selectable input component configured to enable selection of the edits model of the first video, the edits model including a series of edit operations applied to the first video. At 1208, the method 1200 may include in response to selection of the selectable input component, applying the edit operations to a second video. Thus, the selectable input component of the GUI is usable by the second user to easily reuse the edit operations curated by the first user, providing an interesting, already created concept for the second user to try out. This may be particularly helpful for inexperienced users that might enjoy using the video server platform but don't yet have the skills to compose their own original video.

In some implementations, the edit operations may include at least one of adding a text box, formatting the text box, applying a filter, adding a sticker, adding or modifying an audio track, setting coordinates of the text box or sticker, or setting a timing of the text box or sticker. More types of edit operations may be included as well. Accordingly, the first user has many options available for making a creative video that can entice other users to follow suit. In some implementations, applying the edit operations to the second video is permitted based at least on a sharing permission of the first user. The sharing permission may be set at the video level or the account level. This gives the first user creative control over the first video, and other users are allowed to copy the edits model only if the first user is comfortable allowing them to do so.

At 1210, the method 1200 may include, after the edit operations are applied, including an indication of credit to the first user with the second video. In this manner, the first user is assured that the specific concept of their video edits will not be improperly attributed to someone that was copying them. Furthermore, the credit may include a portion of compensation earned by the second video, in some cases. At 1212, the method 1200 may include displaying a reference video of the first video over the second video in a video editing screen of the graphical user interface. The reference video may provide the second user with a quick and easy check while creating the second video to make sure that the footage and edit operations will match up well. At 1214, the method 1200 may include playing and pausing the reference video in sync with the second video during video filming and/or editing of the second video. In this manner, the second user will be able to pause and restart filming or playback as needed without worrying about finding the same timestamp on the reference video. At 1216, the method 1200 may include adjusting the reference video in at least one of transparency, size, and position in response to input by the second user in the video editing screen. Thus, the reference video may be flexibly modified to fit the circumstances of any individual video and user. Finally, at 1218, the method 1200 may include publishing the second video by the second user on the video server platform. Once published, the second video may be viewed by other users who may also want to try using the same edits model.

In some embodiments, the methods and processes described herein may be tied to a computing system of one or more computing devices. In particular, such methods and processes may be implemented as a computer-application program or service, an application-programming interface (API), a library, and/or other computer-program product.

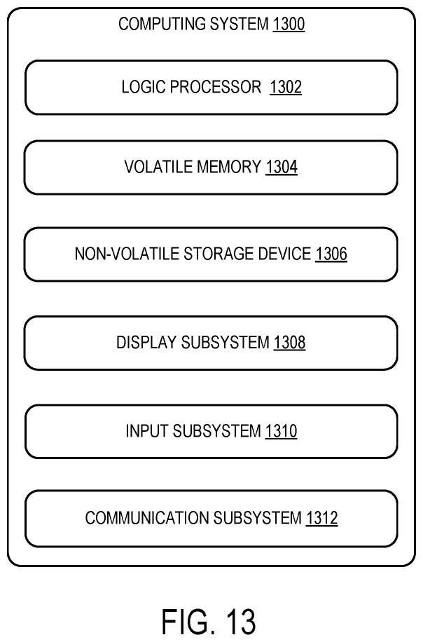

FIG. 13 schematically shows a non-limiting embodiment of a computing system 1300 that can enact one or more of the methods and processes described above. Computing system 1300 is shown in simplified form. Computing system 1300 may embody the computing system 100 described above and illustrated in FIGS. 1 and 2. Computing system 1300 may take the form of one or more personal computers, server computers, tablet computers, home-entertainment computers, network computing devices, gaming devices, mobile computing devices, mobile communication devices (e.g., smartphone), and/or other computing devices, and wearable computing devices such as smart wristwatches and head mounted augmented reality devices.

Computing system 1300 includes a logic processor 1302 volatile memory 1304, and a non-volatile storage device 1306. Computing system 1300 may optionally include a display subsystem 1308, input subsystem 1310, communication subsystem 1312, and/or other components not shown in FIG. 13.

Logic processor 1302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1306 includes one or more physical devices configured to hold instructions executable by the logic processors to implement the methods and processes described herein. When such methods and processes are implemented, the state of non-volatile storage device 1306 may be transformed—e.g., to hold different data.

Non-volatile storage device 1306 may include physical devices that are removable and/or built-in. Non-volatile storage device 1306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1306 may include nonvolatile, dynamic, static, read/write, read-only, sequential-access, location-addressable, file-addressable, and/or content-addressable devices. It will be appreciated that non-volatile storage device 1306 is configured to hold instructions even when power is cut to the non-volatile storage device 1306.

Volatile memory 1304 may include physical devices that include random access memory. Volatile memory 1304 is typically utilized by logic processor 1302 to temporarily store information during processing of software instructions. It will be appreciated that volatile memory 1304 typically does not continue to store instructions when power is cut to the volatile memory 1304.

Aspects of logic processor 1302, volatile memory 1304, and non-volatile storage device 1306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1300 typically implemented in software by a processor to perform a particular function using portions of volatile memory, which function involves transformative processing that specially configures the processor to perform the function. Thus, a program may be instantiated via logic processor 1302 executing instructions held by non-volatile storage device 1306, using portions of volatile memory 1304. It will be understood that different modules, programs, and/or engines may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display subsystem 1308 may be used to present a visual representation of data held by non-volatile storage device 1306. The visual representation may take the form of a GUI. As the herein described methods and processes change the data held by the non-volatile storage device, and thus transform the state of the non-volatile storage device, the state of display subsystem 1308 may likewise be transformed to visually represent changes in the underlying data. Display subsystem 1308 may include one or more display devices utilizing virtually any type of technology. Such display devices may be combined with logic processor 1302, volatile memory 1304, and/or non-volatile storage device 1306 in a shared enclosure, or such display devices may be peripheral display devices.

When included, input subsystem 1310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1312 may be configured to communicatively couple various computing devices described herein with each other, and with other devices. Communication subsystem 1312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1300 to send and/or receive messages to and/or from other devices via a network such as the Internet.

The following paragraphs provide additional support for the claims of the subject application. One aspect provides a computing system. The computing system comprises a client computing device including a processor configured to execute a client program to display a first video published by a first user on a video server platform, to a second user viewing the first video, display a graphical user interface, the graphical user interface including a selectable input component configured to enable selection of an edits model of the first video, the edits model including a series of edit operations applied to the first video, in response to selection of the selectable input component, apply the edit operations to a second video, and publish the second video by the second user on the video server platform for viewing by other users. In this aspect, additionally or alternatively, the edit operations include at least one of adding a text box, formatting the text box, applying a filter, adding a sticker, adding or modifying an audio track, setting coordinates of the text box or sticker, or setting a timing of the text box or sticker. In this aspect, additionally or alternatively, the client program is permitted to apply the edit operations to the second video based at least on a sharing permission of the first user. In this aspect, additionally or alternatively, the video server platform is configured to store the edits model in a video object including the first video, or include an edits model identifier in the video object referencing a stored location of the edits model. In this aspect, additionally or alternatively, after the edit operations are applied, the second video includes an indication of credit to the first user. In this aspect, additionally or alternatively, the graphical user interface is configured to, after the edit operations are applied, permit modifications of one or more of the edit operations by the second user before the second video is published. In this aspect, additionally or alternatively, the graphical user interface further includes a video editing screen in which a reference video of the first video that is displayed over the second video. In this aspect, additionally or alternatively, the reference video is configured to play and pause in sync with the second video during video filming and/or editing of the second video. In this aspect, additionally or alternatively, the reference video is adjustable in at least one of transparency, size, and position by the second user in the video editing screen. In this aspect, additionally or alternatively, the client computing device is further configured to execute the client program to display a plurality of videos that include the edits model of the first video, or display a list of user accounts that published the plurality of videos.

Another aspect provides a method. The method comprises displaying a first video published by a first user on a video server platform, to a second user viewing the first video. The method comprises displaying a graphical user interface including a selectable input component configured to enable selection of an edits model of the first video, the edits model including a series of edit operations applied to the first video. The method comprises in response to selection of the selectable input component, applying the edit operations to a second video. The method comprises publishing the second video by the second user on the video server platform. In this aspect, additionally or alternatively, the edit operations include at least one of adding a text box, formatting the text box, applying a filter, adding a sticker, adding or modifying an audio track, setting coordinates of the text box or sticker, or setting a timing of the text box or sticker. In this aspect, additionally or alternatively, the applying the edit operations to the second video is permitted based at least on a sharing permission of the first user. In this aspect, additionally or alternatively, the method further comprises storing the edits model in a video object including the first video, or including an edits model identifier in the video object referencing a stored location of the edits model, on the video server platform. In this aspect, additionally or alternatively, the method further comprises, after the edit operations are applied, including an indication of credit to the first user with the second video. In this aspect, additionally or alternatively, the method further comprises displaying a reference video of the first video over the second video in a video editing screen of the graphical user interface. In this aspect, additionally or alternatively, the method further comprises playing and pausing the reference video in sync with the second video during video filming and/or editing of the second video. In this aspect, additionally or alternatively, the method further comprises adjusting the reference video in at least one of transparency, size, and position in response to input by the second user in the video editing screen.

Another aspect provides a computing system. The computing system comprises a server computing device of a video server platform. The server computing device is configured to receive a first video by a first user of a first client computing device, receive a sharing permission from the first user of the first client computing device indicating that an edits model of the first video can be shared with and used by other users of the video server platform, and publish the first video on the video server platform. The server computing device is configured to, in response to a viewing request by a second user of a second client computing device, send the first video to the second user for viewing. The server computing device is configured to send the edits model of the first video to the second user, the edits model including a series of edit operations applied to the first video, and publish a second video by the second user on the video server platform, the edit operations having been applied to the second video in response to selection by the second user of a selectable input component in a graphical user interface. In this aspect, additionally or alternatively, the edit operations include at least one of adding a text box, formatting the text box, applying a filter, adding a sticker, adding or modifying an audio track, setting coordinates of the text box or sticker, or setting a timing of the text box or sticker.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. If used herein, the phrase “and/or” means any or all of multiple stated possibilities.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a client computing device that is a mobile device and includes a processor configured to execute a client program to:
display a first video published by a first user on a social media video server platform, to a second user viewing the first video;
display a graphical user interface, the graphical user interface including a selectable input component configured to enable selection of an edits model of the first video, the edits model including a series of edit operations applied to the first video;
display a plurality of videos that include the edits model of the first video and are published by a plurality of users, or display a list of user accounts of the plurality of users that published the plurality of videos;
in response to selection of the selectable input component, apply the edit operations to a second video in a video editing screen in which a reference video of the first video is displayed over the second video; and
publish the second video by the second user on the social media video server platform for viewing by other users.

2. The computing system of claim 1, wherein the edit operations include at least one of adding a text box, formatting the text box, applying a filter, adding a sticker, adding or modifying an audio track, setting coordinates of the text box or sticker, or setting a timing of the text box or sticker.

3. The computing system of claim 1, wherein the client program is permitted to apply the edit operations to the second video based at least on a sharing permission of the first user.

4. The computing system of claim 1, wherein the social media video server platform is configured to store the edits model in a video object including the first video, or include an edits model identifier in the video object referencing a stored location of the edits model.

5. The computing system of claim 1, wherein after the edit operations are applied, the second video includes an indication of credit to the first user.

6. The computing system of claim 1, wherein the graphical user interface is configured to, after the edit operations are applied, permit modifications of one or more of the edit operations by the second user before the second video is published.

7. (canceled)

8. The computing system of claim 1, wherein the reference video is configured to play and pause in sync with the second video during video filming of the second video.

9. The computing system of claim 1, wherein the reference video is adjustable in at least one of transparency, size, and position by the second user in the video editing screen.

10. (canceled)

11. A method, comprising:
displaying a first video published by a first user on a social media video server platform, to a second user viewing the first video on a client computing device that is a mobile device;
displaying, on the client computing device, a graphical user interface including a selectable input component configured to enable selection of an edits model of the first video, the edits model including a series of edit operations applied to the first video;
displaying, on the client computing device, a plurality of videos that include the edits model of the first video and are published by a plurality of users, or displaying a list of user accounts of the plurality of users that published the plurality of videos:
in response to selection of the selectable input component, applying the edit operations to a second video in a video editing screen in which a reference video of the first video is displayed over the second video; and
publishing the second video by the second user on the social media video server platform.

12. The method of claim 11, wherein the edit operations include at least one of adding a text box, formatting the text box, applying a filter, adding a sticker, adding or modifying an audio track, setting coordinates of the text box or sticker, or setting a timing of the text box or sticker.

13. The method of claim 11, wherein the applying the edit operations to the second video is permitted based at least on a sharing permission of the first user.

14. The method of claim 11, further comprising storing the edits model in a video object including the first video, or including an edits model identifier in the video object referencing a stored location of the edits model, on the social media video server platform.

15. The method of claim 11, further comprising, after the edit operations are applied, including an indication of credit to the first user with the second video.

16. (canceled)

17. The method of claim 11, further comprising playing and pausing the reference video in sync with the second video during video filming and/or editing of the second video.

18. The method of claim 11, further comprising adjusting the reference video in at least one of transparency, size, and position in response to input by the second user in the video editing screen.

19. A computing system, comprising:
a server computing device of a social media video server platform, the server computing device including processing circuitry and being configured to:
receive a first video by a first user of a first client computing device;
receive a sharing permission from the first user of the first client computing device indicating that an edits model of the first video can be shared with and used by other users of the social media video server platform;
publish the first video on the social media video server platform;
in response to a viewing request by a second user of a second client computing device, the second client computing device being a mobile device, send the first video to the second user for viewing;
send a plurality of videos that include the edits model of the first video and are published by a plurality of users, or send a list of user accounts of the plurality of users that published the plurality of videos, to the second user for display;
send the edits model of the first video to the second user, the edits model including a series of edit operations applied to the first video; and
publish a second video by the second user on the social media video server platform, the edit operations having been applied to the second video in a video editing screen of a graphical user interface in which a reference video of the first video is displayed over the second video in response to selection by the second user of a selectable input component in the graphical user interface.

20. The computing system of claim 19, wherein the edit operations include at least one of adding a text box, formatting the text box, applying a filter, adding a sticker, adding or modifying an audio track, setting coordinates of the text box or sticker, or setting a timing of the text box or sticker.

21. The computing system of claim 1, wherein the reference video is configured to play and pause in sync with the second video during editing of the second video.

22. The computing system of claim 5, wherein the indication of credit includes at least one of a link to a profile of the first user and a link to the first video on the social media platform.

23. The computing system of claim 1, wherein the graphical user interface further includes a video sharing screen including a contacts pane operable to send a link to the first video to one or more contacts of the second user, an application pane operable to send a link or create a post advertising the first video, and the selectable input component.
